(19) United States
(12) Patent Application Publication
(10) Pub. No.: US 2021/0304519 A1
(43) Pub. Date: Sep. 30, 2021

(54) ACCOMMODATION AREA MANAGEMENT DEVICE

(71) Applicant: HONDA MOTOR CO., LTD., Tokyo (JP)

(72) Inventors: Junpei NOGUCHI, Saitama (JP); Gaku SHIMAMOTO, Saitama (JP); Yuta TAKADA, Tokyo (JP); Ryoma TAGUCHI, Tokyo (JP)

(73) Assignee: HONDA MOTOR CO., LTD., Tokyo (JP)

(21) Appl. No.: 17/214,361

(22) Filed: Mar. 26, 2021

(30) Foreign Application Priority Data
Mar. 30, 2020 (JP) 2020-061632

(51) Int. Cl. G07B 15/02; G06Q 10/02

(52) U.S. Cl. CPC G07B 15/02; G06Q 10/02

(57) ABSTRACT

An accommodation area management device includes: a reception unit configured to receive from a user of a moving body an instruction that a task is to be executed for the moving body; and a processing unit configured to perform processing of generating an accommodation plan for the moving body when the moving body is accommodated in an accommodation area. Before the moving body approaches the accommodation area and when the moving body approaches the accommodation area, the reception unit can receive from the user the instruction that the task is to be executed for the moving body. The processing unit generates the accommodation plan including the execution of the task if the instruction that the task is to be executed for the moving body is received before the moving body approaches the accommodation area and the instruction is received again when the moving body approaches the accommodation area.

### CROSS-REFERENCE TO RELATED APPLICATIONS

The present application claims the benefit of priority of Japanese Patent Application No. 2020-061632, filed on Mar. 30, 2020, the content of which is incorporated herein by reference.

### TECHNICAL FIELD

The present invention relates to an accommodation area management device.

### BACKGROUND ART

In a related art, known is a technology for managing the implementation of various services (cleaning, charging, or the like) for a vehicle parked in a parking lot. For example, JP-A-2018-500668 discloses a parking lot management server in which a reservation related to service is received from a user of a vehicle scheduled to use a parking lot via a communication network, and an implementation plan and adjustment of the reserved service are automatically performed.

However, in a related art, in an accommodation area (a parking lot) that accommodates a moving body such as a vehicle or the like and that can perform a predetermined task (a service) for the moving body in response to a request from a user, the task may not be able to be efficiently performed and there is room for improvement from a viewpoint of effectively utilizing the accommodation area. For example, when a vehicle enters the parking lot and then a reservation of service for the vehicle is canceled, an implementation plan of the service prepared for the vehicle is wasted, which causes loss of an opportunity of providing the service that could have been originally provided to other vehicles.

### SUMMARY

The present invention provides an accommodation area management device capable of efficiently performing a task and effectively utilizing an accommodation area.

According to an aspect of the invention, there is provided an accommodation area management device configured to manage an accommodation area capable of accommodating a moving body, the accommodation area being an area capable of executing a predetermined task for the accommodated moving body, the accommodation area management device including: a reception unit configured to receive from a user of the moving body an instruction that the task is to be executed for the moving body; and a processing unit configured to perform processing of generating an accommodation plan for the moving body when the moving body is accommodated in the accommodation area, where: before the moving body approaches the accommodation area and when the moving body approaches the accommodation area, the reception unit can receive from the user the instruction that the task is to be executed for the moving body; and the processing unit generates the accommodation plan including the execution of the task if the instruction that the task is to be executed for the moving body is received before the moving body approaches the accommodation area and the instruction that the task is to be executed for the moving body is received again when the moving body approaches the accommodation area.

According to the aspect of the present invention, it is possible to efficiently perform a task and to effectively utilize an accommodation area.

### BRIEF DESCRIPTION OF THE DRAWINGS

FIG. 1 is a diagram illustrating an example of a configuration of a vehicle system according to the embodiment;

FIG. 2 is a diagram illustrating an example of a parking lot managed by a parking lot management device;

FIG. 3 is a diagram illustrating an example of a configuration of the parking lot management device:

FIG. 4 is a diagram illustrating an example of a reservation information table:

FIG. 5 is a diagram illustrating an example of a parking space management table;

FIG. 6 is a diagram illustrating an example of a parking plan management table;

FIG. 7 is a diagram illustrating an example of a predicted required time information table:

FIG. 8 is a flowchart illustrating an example of parking plan generation processing performed by the parking lot management device; and

FIG. 9 is a flowchart illustrating an example of the parking plan generation processing performed by the parking lot management.

### DESCRIPTION OF EMBODIMENTS

Hereinafter, an embodiment of an accommodation area management device of the present invention will be described with reference to the accompanying drawings. In the following embodiment, an example in which a moving body in the present invention is a vehicle and an accommodation area in the present invention is a parking lot will be described. Further, in the following embodiment, an example in which the accommodation area management device of the present invention is a parking lot management device for managing the parking lot will be described. Further, in the following embodiment, various services such as car wash (cleaning), charging, or the like provided to the vehicle in the parking lot are referred to as tasks. Further, the tasks may include vehicle maintenance (for example, filling tires with air), updating vehicle software (for example, updating a vehicle system which will be described later), exiting from the parking lot, or the like.

[Vehicle System]

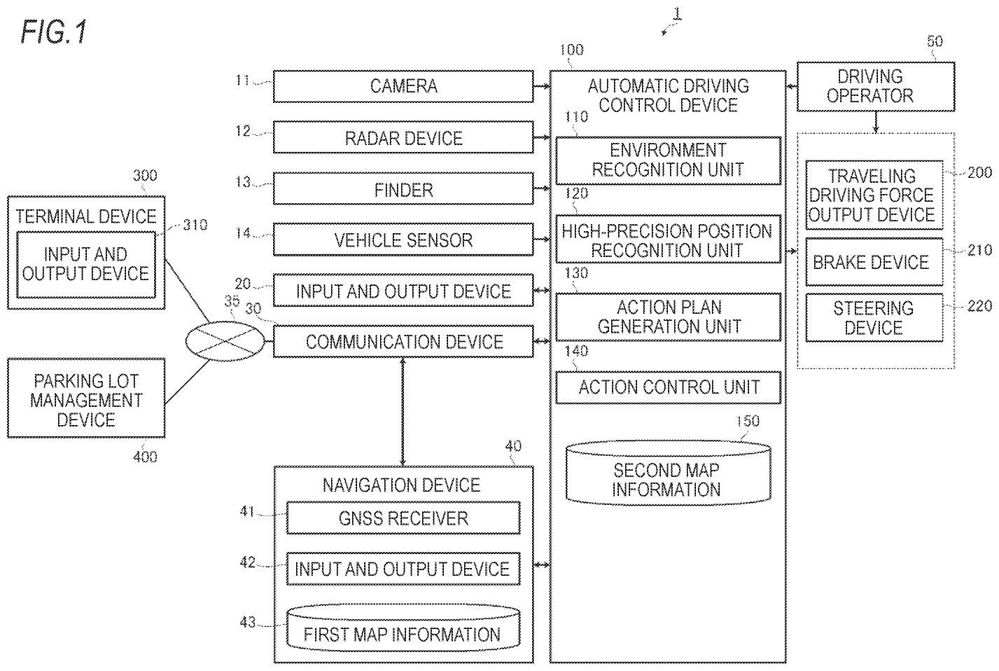

First, a vehicle of the embodiment will be described. In FIG. 1, a vehicle system 1 is mounted on the vehicle. The vehicle on which the vehicle system 1 is mounted (hereinafter, also referred to as a vehicle M) is a vehicle including a drive source and wheels (for example, two wheels, three wheels, or four wheels) including a driving wheel driven by the power of the drive source. The drive source of the vehicle M is, for example, an electric motor. Further, the drive source of the vehicle M may be an internal combustion engine such as a gasoline engine or the like, and a combination of the electric motor and the internal combustion engine.

The vehicle system 1 has a function capable of performing all driving tasks related to the vehicle M at least in a limited specific area (for example, in a parking lot PA which will be described later). Here, the driving task is, for example, a real-time driving function required for controlling the vehicle M, such as controlling the left-right movement of the vehicle M (steering), controlling the movement in the front-rear direction (acceleration and deceleration), and monitoring the driving environment, and a tactical function such as planning of a traveling track, or the like.

As illustrated in FIG. 1, the vehicle system 1 includes, for example, a camera 11, a radar device 12, a finder 13, a vehicle sensor 14, an input and output device 20, a communication device 30, a navigation device 40, a driving operator 50, an automatic driving control device 100, a traveling driving force output device 200, a brake device 210, and a steering device 220. The respective devices are communicably connected to each other via a wired or wireless communication network. The communication network connecting the respective devices is, for example, a Controller Area Network (CAN).

The camera 11 is a digital camera that photographs the periphery of the vehicle M (for example, in front of the vehicle M) and outputs image data acquired by photographing to the automatic driving control device 100. The radar device 12 is, for example, a radar device using a radio wave in a millimeter wave band, detects a position of an object existing in the periphery of the vehicle M (for example, in front of, behind, and to the side of the vehicle M), and outputs the detection result thereof to the automatic driving control device 100.

The finder 13 is, for example, a Laser Imaging Detection and Ranging (LIDAR), uses a predetermined laser beam to measure a distance to the object (a target object) existing in the vicinity of the vehicle M (for example, in front of, behind, and to the side of the vehicle M), and outputs the measurement result to the automatic driving control device 100.

The vehicle sensor 14 includes, for example, a vehicle speed sensor that detects the speed of the vehicle M, an acceleration sensor that detects the acceleration of the vehicle M, an angular velocity sensor that detects the angular velocity around the vertical axis of the vehicle M, an orientation sensor that detects the direction of the vehicle M, or the like. Further, the vehicle sensor 14 includes a radio wave intensity sensor that detects the intensity of radio waves (that is, a communication intensity) used for communication by the communication device 30 which will be described later. The vehicle sensor 14 outputs the detection result of each sensor to the automatic driving control device 100.

The input and output device 20 includes an output device that outputs various information to a user of the vehicle M (hereinafter, also simply referred to as a user) and an input device that receives various input operations from the user of the vehicle M. The output device of the input and output device 20 is, for example, a display that performs displaying based upon the processing result of the automatic driving control device 100. The output device may be a speaker, a buzzer, an indicator light, or the like. Further, the input device of the input and output device 20 is, for example, a touch panel and an operation button (a key, a switch, or the like) that outputs an operation signal corresponding to the input operation received from the user to the automatic driving control device 100.

The communication device 30 is connected to a network 35 and communicates with another device provided outside the vehicle system 1 via the network 35. The network 35 is, for example, a mobile communication network, a Wi-Fi network, Bluetooth (registered trademark), Dedicated Short Range Communication (DSRC), or the like.

The communication device 30 communicates with, for example, a terminal device 300 of the user of the vehicle M and a parking lot management device 400 that manages the parking lot PA where the vehicle M can be parked. The terminal device 300 is, for example, a smartphone, a tablet terminal, or the like, and is an electronic device connected to the network 35 and including an input and output device 310. The input and output device 310 is, for example, a display that displays various information to the user, a touch panel that receives the input operation of the user, or the like. The parking lot PA and the parking lot management device 400 will be described later.

The navigation device 40 includes a Global Navigation Satellite System (GNSS) receiver 41 and an input and output device 42. Further, the navigation device 40 includes a storage device (not illustrated) such as a flash memory, or the like, and first map information 43 is stored in the storage device. The first map information 43 is, for example, information representing a road shape by a link indicating a road and a node connected by the link. Further, the first map information 43 may include information representing the curvature of the road and a Point Of Interest (POI).

The GNSS receiver 41 specifies the latitude and longitude of a point where the vehicle M is positioned as the position of the vehicle M based upon the signal received from a GNSS satellite. Further, the navigation device 40 may specify or correct the position of the vehicle M by an Inertial Navigation System (INS) using the output of the vehicle sensor 14.

The input and output device 42 includes an output device that outputs various information to the user of the vehicle M and an input device that receives various input operations from the user of the vehicle M. The output device of the input and output device 42 is, for example, a display that performs displaying based upon the processing result of the navigation device 40 (for example, displays a route on the map, which will be described later). Further, the input device of the input and output device 42 is, for example, a touch panel and an operation button (a key, a switch, or the like) that outputs the operation signal corresponding to the input operation received from the user to the navigation device 40. The input and output device 42 may be shared with the input and output device 20.

For example, the navigation device 40 determines a route from the position of the vehicle M specified by the GNSS receiver 41 to the destination inputted by the user (hereinafter, also referred to as the route on the map) with reference to the first map information 43. Next, the navigation device 40 guides the determined route on the map to the user by the input and output device 42. Further, the navigation device 40 outputs information indicating the position of the vehicle M specified by the GNSS receiver 41 and information indicating the determined route on the map to the automatic driving control device 100.

The navigation device 40 may be realized by a function of the terminal device 300. Further, for example, the communication device 30 is configured to transmit the information indicating the position of the vehicle M and the destination inputted by the user to a server device (a navigation server) outside the vehicle system 1, such that the function of the navigation device 40 may be realized by the server device.

The driving operator 50 includes an operator such as an accelerator pedal, a brake pedal, a shift lever, a steering wheel, a deformed steering wheel, a joystick, and the like. The driving operator 50 is provided with a sensor that detects the amount of the operation or presence or absence of operation on the driving operator 50. The detection result by the sensor of the driving operator 50 is outputted to a part or all of the automatic driving control device 100, the traveling driving force output device 200, the brake device 210, and the steering device 220.

The traveling driving force output device 200 outputs the traveling driving force (torque) for the vehicle M to travel to the driving wheel. The traveling driving force output device 200 includes, for example, an electric motor and an electric motor Electronic Control Unit (ECU) that controls the electric motor. The electric motor ECU controls the electric motor based upon the detection result by the sensor of the driving operator 50 (for example, the accelerator pedal) and control information from the automatic driving control device 100. Further, when the vehicle M includes an internal combustion engine and a transmission as a drive source, the traveling driving force output device 200 may include the internal combustion engine, the transmission, and the ECU that controls the internal combustion engine and the transmission.

The brake device 210 includes, for example, a brake caliper, a cylinder that transmits hydraulic pressure to the brake caliper, an electric motor that generates the hydraulic pressure in the cylinder, and a brake ECU. The brake ECU controls the electric motor of the brake device 210 based upon the detection result by the sensor of the driving operator 50 (for example, the brake pedal) and the control information from the automatic driving control device 100, and outputs the brake torque in accordance with a braking operation to each wheel.

The steering device 220 includes, for example, a steering ECU and an electric motor. The electric motor of the steering device 220 changes the direction of the steering wheel by, for example, applying a force to a rack and pinion mechanism. The steering ECU drives the electric motor of the steering device 220 based upon the detection result by the sensor of the driving operator 50 (for example, the steering wheel) and the control information from the automatic driving control device 100, and changes the direction of the steering wheel.

[Automatic Driving Control Device]

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like accessible to each functional unit (for example, the high-precision position recognition unit 120) of the automatic driving control device 100, and second map information 150 is stored in the storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time when the communication device 30 communicates with another device. For example, when the vehicle M enters the parking lot PA, the communication device 30 receives information indicating a lane in the parking lot PA, a position of each parking space, and the like (hereinafter, also referred to as map information in the parking lot) from the parking lot management device 400. Next, the automatic driving control device 100 updates the second map information 150 to incorporate the received map information in the parking lot into the second map information 150. As a result, the automatic driving control device 100 can specify the position of each parking space in the parking lot PA, or the like with reference to the second map information 150.

The environment recognition unit 110 performs sensor fusion processing on the information to be acquired by a part or all of the camera 11, the radar device 12, and the finder 13, recognizes an object existing in the vicinity of the vehicle M and also recognizes the position of the object. The environment recognition unit 110 recognizes, for example, obstacles, road shapes, traffic lights, guardrails, utility poles, surrounding vehicles (including the traveling status such as the speed, the acceleration, or the like, and parking state), lane marks, pedestrians, or the like, and also recognizes positions thereof.

The high-precision position recognition unit 120 recognizes the detailed position and posture of the vehicle M with reference to the position of the vehicle M specified by the navigation device 40, the detection result by the vehicle sensor 14, the image photographed by the camera 11, the second map information, or the like. The high-precision position recognition unit 120 recognizes, for example, the traveling lane on which the vehicle M is traveling, or recognizes a relative position a posture of the own vehicle with respect to the traveling lane. Further, the high-precision position recognition unit 120 also recognizes, for example, the position of the vehicle M in the parking lot PA, or the like.

The action plan generation unit 130 generates an action plan of the vehicle M. Specifically, the action plan generation unit 130 generates a target track on which the vehicle M will travel in the future as the action plan of the vehicle M. For example, the target track is information represented by arranging points (track points) to be reached by the vehicle M for each predetermined traveling distance (for example, about several [m]). Further, the target track may include information on speed elements such as the target speed, the target acceleration, or the like of the vehicle M at each predetermined time or at each track point. The action plan generation unit 130 generates the action plan, for example, according to an instruction of the parking lot management device 400 received by the communication device 30.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based upon the speed element associated with the target track, or controls the steering device 220 according to a curvature degree of the target track.

Each functional unit of the automatic driving control device 100 is realized, for example, by a Central Processing Unit (CPU) executing a predetermined program (software). Further, a part or all of the functional units of the automatic driving control device 100 may be realized by hardware such as Large Scale Integration (LSI), an Application Specific Integrated Circuit (ASIC), a Field-Programmable Gate Array (FPGA), a Graphics Processing Unit (GPU), or the like, and for example, the storage device for storing the second map information 150 and the high-precision position recognition unit 120 may be realized by a Map Positioning Unit (MPU). Further, a part or all of the functional units of the automatic driving control device 100 may be realized by the cooperation of the software and the hardware.

[Parking Lot Managed by Parking Lot Management Device]

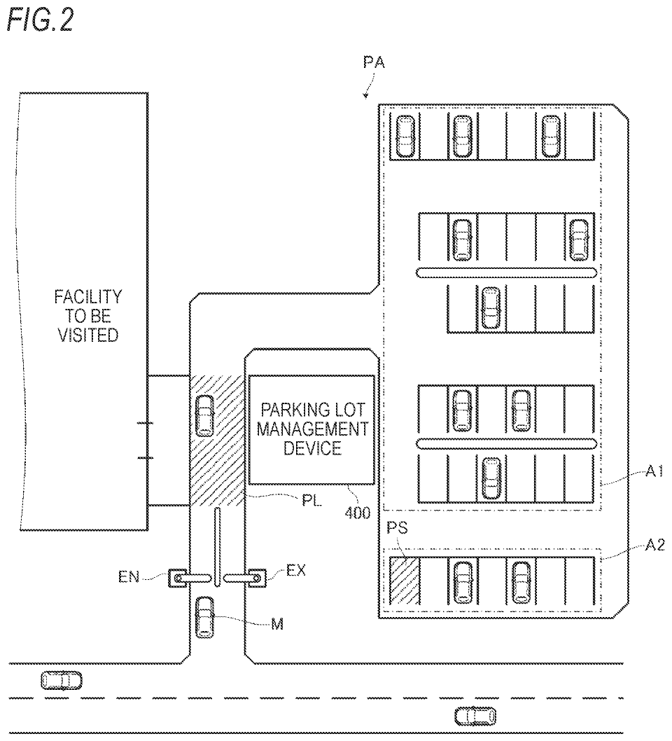

Next, an example of the parking lot PA will be described with reference to FIG. 2. As illustrated in FIG. 2, the parking lot PA is a parking lot managed by the parking lot management device 400 and is an automatic valet parking type parking lot provided as an annex in a visiting facility to be visited by a user. The parking lot PA includes a first parking area A1 and a second parking area A2. A plurality of parking spaces PS capable of accommodating vehicles (for example, the vehicle M) are provided in each of the first parking area A1 and the second parking area A2, and a platform PL is provided in front of the first parking area A1 and the second parking area A2. The first parking area A1 is an area that does not include equipment (car wash equipment, power supply equipment, vehicle maintenance equipment, or the like.) capable of executing tasks for a vehicle being parked. The second parking area A2 is an area that includes equipment capable of executing tasks for the vehicle being parked.

Further, an entrance gate EN through which the vehicle passes when entering the parking lot PA, and an exit gate EX through which the vehicle passes when exiting from the parking lot PA are provided in front of the platform PL of the parking lot PA.

Hereinafter, an example in which the user of the vehicle M uses the parking lot PA will be described.

Before using the parking lot PA, the user of the vehicle M makes a reservation for using the parking lot PA with respect to the parking lot management device 400 that manages the parking lot PA by using the terminal device 300. Contents designated at the time of making a reservation for using the parking lot PA include a date and time of using the parking lot PA (a scheduled entry date and time, and scheduled exit date and time) and a task desired to be executed for the vehicle M. For example, the user of the vehicle M inputs the date and time of using the parking lot PA, a task desired to be executed for the vehicle M, and identification information of the vehicle M into the terminal device 300, and transmits the pieces of information to the parking lot management device 400, thereby making a reservation for using the parking lot PA. After that, when the date and time of the reservation therefor are reached, the user of the vehicle M rides the vehicle M on the platform PL through the entrance gate EN and gets off from the vehicle M at the platform PL.

After the user gets off the vehicle M, the vehicle M performs automatic driving and starts a self-propelled entry event to move the vehicle M to the parking space PS in the parking lot PA. For example, the user transmits a request for starting the self-propelled entry event to the parking lot management device 400 by using the terminal device 300. In response to the request, the parking lot management device 400 instructs the vehicle M to perform the self-propelled entry event for allowing the vehicle M to be parked in a predetermined parking space PS. According to this instruction, the vehicle M moves to the parking space PS instructed by the parking lot management device 400 while being guided by the parking lot management device 400 and performing sensing by the camera 11, the radar device 12, or the finder 13.

Further, when the vehicle M exits from the parking lot PA, the vehicle M performs the automatic driving and performs a self-propelled exit event to move the vehicle M from the parking space PS to the platform PL. For example, the user transmits a request for starting the self-propelled exit event to the parking lot management device 400 by using the terminal device 300. In response to the request, the parking lot management device 400 instructs the vehicle M to perform the self-propelled exit event to move the vehicle M from the parking space PS where the vehicle M is parked to the platform PL. According to this instruction, the vehicle M moves to the platform PL while being guided by the parking lot management device 400 and performing sensing by the camera 11, the radar device 12, or the finder 13. The user of the vehicle M gets on the vehicle M at the platform PL and exits from the parking lot PA through the exit gate EX.

Further, the vehicle M may execute parking again, so-called “re-parking”, in which the parking position of the vehicle M being parked at the parking lot PA is changed to another parking position in the parking lot PA. This re-parking is appropriately executed by a control instruction by the parking lot management device 400 or a voluntarily automatic driving by the vehicle M itself.

[Parking Lot Management Device]

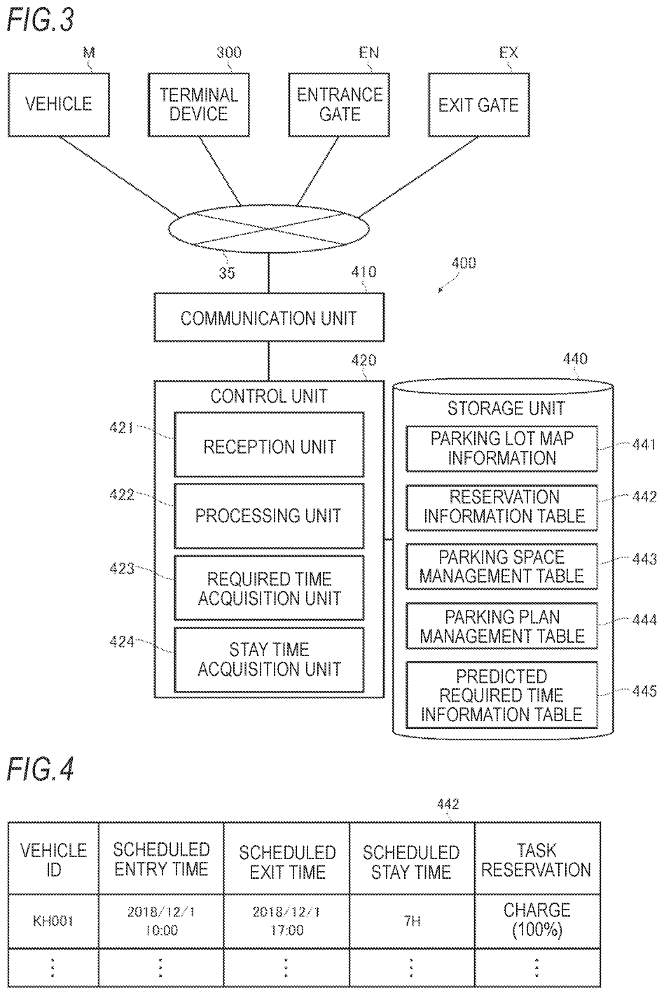

Next, an example of a configuration of the parking lot management device 400 will be described with reference to FIG. 3. As illustrated in FIG. 3, the parking lot management device 400 includes, for example, a communication unit 410, a control unit 420, and a storage unit 440. The control unit 420 includes, for example, a reception unit 421, a processing unit 422, a required time acquisition unit 423, and a stay time acquisition unit 424. Each component of the control unit 420 may be realized, for example, by a hardware processor such as a CPU or the like executing a program (software). A part or all of these components may be realized by hardware (including a circuit unit; circuitry) such as LSI, ASIC, FPGA, GPU, or the like, or may be realized by the cooperation of the software and the hardware. The program may be stored in advance in a storage device such as an HDD, a flash memory, or the like (a storage device including a non-transient storage medium) and may be stored in a removable storage medium such as a DVD, a CD-ROM, or the like (the non-transient storage medium) and then installed by attaching the storage medium to a drive device.

Pieces of information such as parking lot map information 441, a reservation information table 442, a parking space management table 443, a parking plan management table 444, a predicted required time information table 445, or the like are stored in the storage unit 440. The storage unit 440 is realized by an HDD, a flash memory, or the like.

As illustrated in FIG. 4, information indicating the scheduled entry date and time, information indicating the scheduled exit date and time, information indicating scheduled stay time, and information indicating a task reservation regarding each vehicle specified by the vehicle ID are recorded in the reservation information table 442. The information indicating the task reservation may include a content of a reserved task (“car wash”, “charge 100%”, “charge 50%”, or the like). “H” in the drawing indicates “time” (the same applies hereinafter). For example, a fact that the information indicating the scheduled stay time is “7H” indicates that the scheduled stay time is “7 hours”.

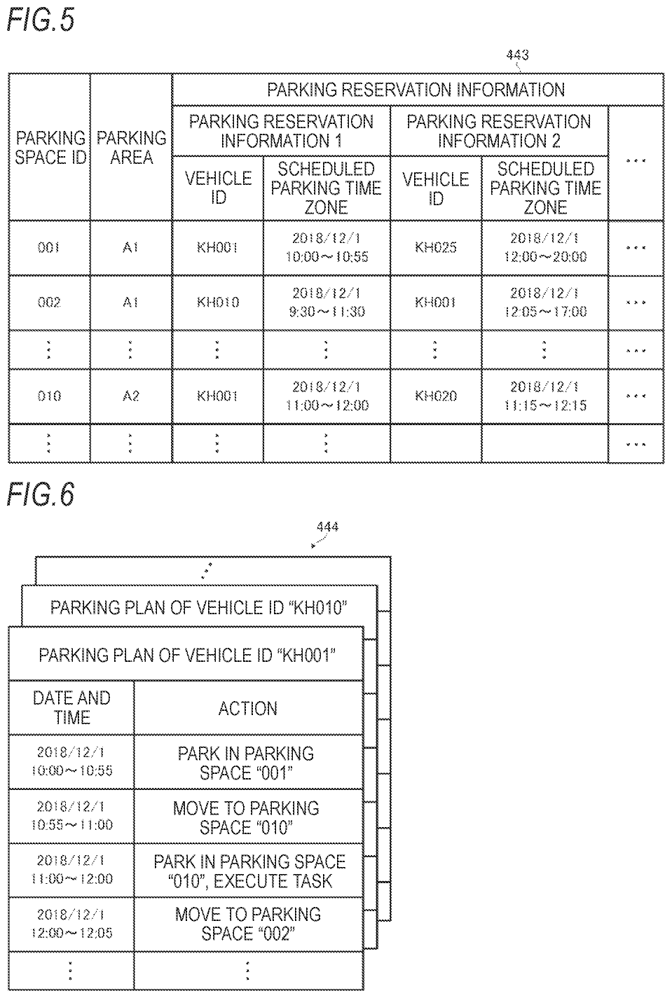

As illustrated in FIG. 5, in the parking space management table 443, with respect to the parking space ID which is identification information of the parking space PS, information (“A1”, “A2”) indicating whether the parking area is the first parking area A1 or the second parking area A2 and parking reservation information are recorded in association with each other. The parking reservation information includes parking reservation information 1, 2, . . . for a plurality of time zones of each parking space PS.

As illustrated in FIG. 6, the parking plan management table 444 is generated for each vehicle ID. In each parking plan management table 444, the scheduled action of each vehicle specified by the vehicle ID for each date and time is recorded.

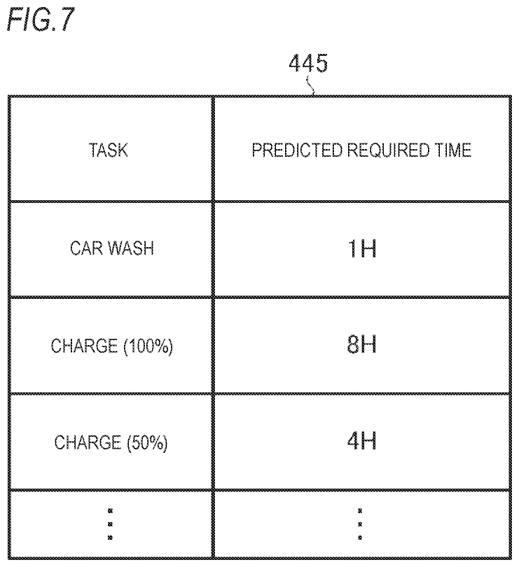

As illustrated in FIG. 7, in the predicted required time information table 445, the task (“car wash”, “charge 100%”, “charge 50%”, or the like) and predicted required time thereof are recorded in association with each other. Here, the “charge 100%” is the task of charging the vehicle until the remaining battery level of the vehicle reaches 100%. The “charge 50%” is the task of charging the vehicle until the remaining battery level of the vehicle reaches 50%.

The communication unit 410 wirelessly (for example, the network 35) communicates with the vehicle M, the terminal device 300, the entrance gate EN, and the exit gate EX. The control unit 420 guides the vehicle M to the parking space PS based upon the information acquired via the communication unit 410 and the information stored in the storage unit 440. The parking lot map information 441 is information that geometrically represents a structure of the parking lot PA. Further, the parking lot map information 441 includes a coordinate of each parking space PS.

The reception unit 421 receives, from the user of the vehicle M, an instruction that the task is to be executed for the vehicle M. More specifically, for example, the reception unit 421 is configured to be able to receive, from the user of the vehicle M, the instruction that the task is to be executed for the vehicle M, before the vehicle M approaches the entrance gate EN (that is, before the vehicle M approaches the parking lot PA) and when the vehicle M arrives before the entrance gate EN (that is, when the vehicle M approaches the parking lot PA). As a result, the reception unit 421 can receive, from the user of the vehicle M, at least twice whether or not the task is executed for the vehicle M. At least one time is, for example, the time when the user makes a reservation for using the parking lot PA, and the remaining one time is, for example, the time just before the vehicle M enters the parking lot PA.

Here, the user of the vehicle M is not limited to a person who uses the vehicle M but may be an owner and a manager of the vehicle M. In this manner, for example, when the vehicle M is a shared car rented out at the parking lot PA, the manager of the vehicle M can execute the task for the vehicle M by using the parking time of the vehicle M in the parking lot PA (that is, by using the time when the vehicle M is not rented).

The processing unit 422 performs processing of generating a parking plan (an accommodation plan) of the vehicle M in the parking lot PA based upon the content received from the reception unit 421. More specifically, before the vehicle M approaches the entrance gate EN, the reception unit 421 receives, from the user of the vehicle M, an instruction that a task is to be executed for the vehicle M. and when the vehicle M arrives before the entrance gate EN and then the reception unit 421 receives, from the user of the vehicle M, the instruction that the task is to be executed therefor, the processing unit 422 generates a parking plan including the execution of the task for the vehicle M.

In this manner, whether to execute the task for the vehicle M is notified at least twice at the timing, that is, before the vehicle M approaches the parking lot PA and when the vehicle M approaches the parking lot PA. If an instruction that the task is to be executed is received when the vehicle M approaches the parking lot PA, a parking plan including the execution of the task for the vehicle M is generated, whereby only when the user of vehicle M intends to execute the task, a parking plan including the execution of the task for the vehicle M can be generated. Thus, it is possible to efficiently perform the task and to effectively utilize the parking lot PA.

Further, if the reception unit 421 receives, from the user of the vehicle M, an instruction that a task is to be executed before the vehicle M approaches the parking lot PA, but the reception unit 421 does not receive, from the user of the vehicle M, the instruction that the task is to be executed when the vehicle approaches the parking lot PA, the processing unit 422 generates a parking plan that does not include the execution of the task for the vehicle M. For example, even though the vehicle M is reserved for a task including “car wash” at the time of making the reservation for using the parking lot PA, a parking plan that does not include the execution of “car wash” for the vehicle M is generated if the reception unit 421 does not receive, from the user of the vehicle M, the instruction that the car wash is to be executed for the vehicle M when the vehicle M approaches the parking lot PA.

In this manner, if the instruction that the reserved task is to be executed for the vehicle M is not received when the vehicle M approaches the parking lot PA, a parking plan that does not include the execution of the reserved task for the vehicle M is generated, thereby making it possible to efficiently execute the task and to effectively utilize the parking lot PA.

The required time acquisition unit 423 acquires information indicating the predicted required time which is a predicted value of required time when the task is executed for the vehicle M. This predicted required time is an example of the required time in the present invention. For example, the required time acquisition unit 423 acquires the information indicating the predicted required time of the task to be executed with reference to the predicted required time information table 445. The required time acquisition unit 423 acquires information on a current state (the remaining battery level or the like) of the vehicle M when acquiring the information indicating the predicted required time and refers to the predicted required time information table 445 in consideration of the information.

Further, the predicted required time is not limited to the required time of the task itself but may include moving time until the task is executed or moving time after the task is executed. For example, the predicted required time when the task of “car wash” is executed for the vehicle M may include time to move the vehicle M to the parking space PS provided with equipment that can execute the task of “car wash”, and time to move the vehicle M from the parking space PS where the task of “car wash” is executed after the task of “car wash” is executed to a predetermined position (for example, the previous parking space PS). Further, when the equipment that can execute the task becomes congested or malfunctions, the vehicle M is in a waiting state for the execution of the task, and delay time (waiting time) may occur until the task can be executed. In such a case, the predicted required time of the task may take the above-described delay time into consideration.

The stay time acquisition unit 424 acquires the information indicating the scheduled stay time which is a predicted value of stay time for the vehicle M to stay in the parking lot PA. Specifically, the stay time acquisition unit 424 acquires the information indicating the scheduled stay time of the vehicle M from the reservation information table 442 by using the vehicle ID of the vehicle M as a key.

When the predicted required time indicated by the information acquired by the required time acquisition unit 423 is shorter than the scheduled stay time indicated by the information acquired by the stay time acquisition unit 424, the processing unit 422 generates a parking plan including the execution of the task for the vehicle M.

In this manner, a parking plan including the execution of the task for the vehicle M is generated on the condition that the predicted required time of the task is shorter than the scheduled stay time of the vehicle M in the parking lot PA, thereby making it possible to prevent the generation of a parking plan that cannot be executed and to improve the convenience of the user of the vehicle M.

Further, when the predicted required time is longer than the scheduled stay time, the processing unit 422 performs processing of notifying the user of the vehicle M of other tasks that can be executed within the scheduled stay time.

In this manner, when the predicted required time for the task is longer than the scheduled stay time of the vehicle M in the parking lot PA, the user of the vehicle M is notified of other tasks that can be executed within the scheduled stay time, thereby making it possible to encourage the user to select another task, to increase an opportunity of executing another task, and to effectively utilize the parking lot PA.

Further, if the instruction that the reserved task is to be executed is not received from the user of the vehicle M when the vehicle M approaches the parking lot PA, that is, if the execution of the reserved task is canceled by the user of the vehicle M, the processing unit 422 performs processing of notifying a user of another vehicle M accommodated in the parking lot PA or approaching the parking lot PA that the aforementioned reserved task can be executed. For example, the reserved task is a task that is received from the user of the vehicle M at the time of making a reservation for using the parking lot PA to be executed for the vehicle M.

In this manner, when a parking plan that does not include the execution of the reserved task for the vehicle M is generated, the user of another vehicle M parked in the parking lot PA or approaching the parking lot PA is notified that the reserved task can be executed, thereby making it possible to increase the opportunity of executing the task and to effectively utilize the parking lot PA.

Further, if the instruction that the task is to be executed is not received before the vehicle M approaches the parking lot PA, and then when the vehicle M approaches the parking lot PA, the processing unit 422 performs processing of notifying the user of the vehicle M that the task can be executed.

In this manner, if the instruction that the task is to be executed is not received before the vehicle M approaches the parking lot PA, and when the vehicle M approaches the parking lot PA, the user of the vehicle M is notified that the task can be executed, thereby making it possible to increase the opportunity of executing the task and to effectively utilize the parking lot PA. Further, for example, at this time, the processing unit 422 may notify the user of the vehicle M of all the tasks that can be executed in the parking lot PA, regardless of whether or not there is a vacancy for each task that can be executed in the parking lot PA. As a result, the parking lot management device 400 can immediately execute a task having a vacancy for the vehicle M in response to a request of the user of the vehicle M. Further, the parking lot management device 400 can also notify the user of the vehicle M of a task not having a vacancy, such that the user of the vehicle M can be informed that this task is provided in the parking lot PA. That is, it is possible to advertise to the user of the vehicle M that the parking lot PA is a parking lot capable of executing this task.

Further, the processing unit 422 may further perform processing of temporarily stopping the vehicle M at a predetermined position. Specifically, before the vehicle M enters the parking lot PA, that is, when the vehicle M approaches the parking lot PA, the processing unit 422 temporarily stops the vehicle M at a predetermined position such as right before the entrance gate EN or the like. Next, while the vehicle M is temporarily stopped as described above, the processing unit 422 receives, from the user of the vehicle M, the instruction that the task is to be executed or gives various notifications to the user of the vehicle M. As a result, it becomes easy for the user of the vehicle M to perform an operation to execute the task, the opportunity of executing the task is increased, and the parking lot PA is effectively utilized.

[Parking Plan Generation Processing Performed by Parking Lot Management Device]

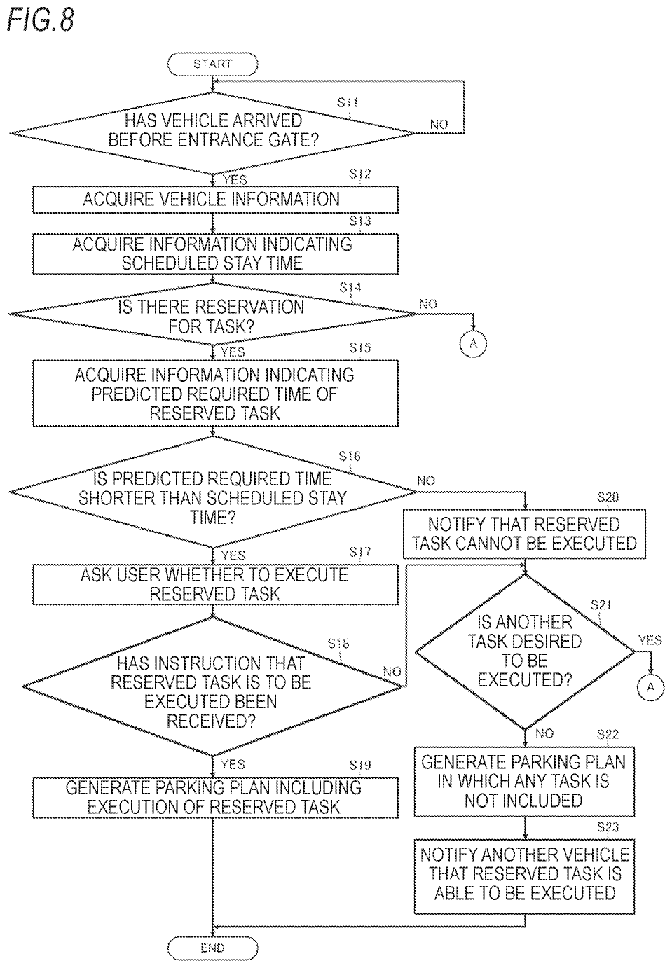

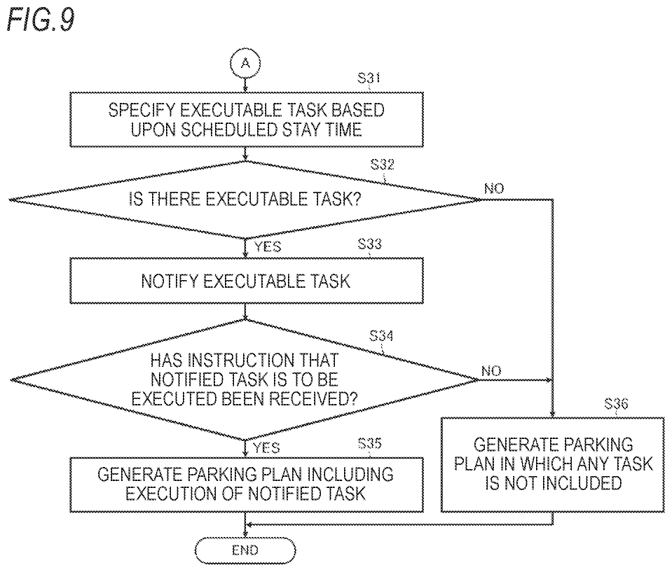

Next, an example of parking plan generation processing performed by the parking lot management device 400 will be described with reference to FIGS. 8 and 9.

As illustrated in FIG. 8, the parking lot management device 400 determines whether or not the vehicle M arrives before the entrance gate EN (step S11). When it is determined that the vehicle M does not arrive before the entrance gate EN (NO in step S11), the parking lot management device 400 waits until the vehicle M arrives.

When it is determined that the vehicle M arrives before the entrance gate EN (YES in step S11), the parking lot management device 400 acquires the vehicle information from the vehicle M (step S12). The vehicle information is information including at least the vehicle ID. Further, the vehicle information includes information on the current internal state of the vehicle (hereinafter, also referred to as internal state information). For example, when the task that can be executed for the vehicle M includes a task for providing a charging service, the vehicle information includes information indicating the remaining battery level of the vehicle M.

Next, the parking lot management device 400 uses the vehicle ID acquired in step S12 as a key to acquire the information indicating the scheduled stay time of the vehicle M in the parking lot PA from the reservation information table 442 (step S13).

Next, the parking lot management device 400 uses the vehicle ID acquired in step S12 as a key to acquire the information indicating a reservation of the task from the reservation information table 442 and determines whether or not there is a reservation for the task to be executed for the vehicle M (S14). When it is determined that there is no reserved task (NO in step S14), the parking lot management device 400 proceeds to the processing of step S31 illustrated in FIG. 9.

On the other hand, when it is determined that there is a reserved task (YES in step S14), the parking lot management device 400 acquires the information indicating the predicted required time of the reserved task with reference to the predicted required time information table 445 (step S15). This processing is performed in consideration of the internal state information included in the vehicle information acquired from the vehicle M by the processing of step S12.

In the embodiment, the parking lot management device 400 is configured to acquire the predicted required time (that is, the required time when the task is executed) in consideration of the internal state information, but the present invention is not limited thereto. For example, with respect to the predicted required time for a car wash (that is, the required time), the parking lot management device 400 may acquire the predicted required time therefor from a predetermined time, such as 2 hours when the size of a vehicle body is “large” and 1 hour when the size of a vehicle body is “medium”. In the same manner, with respect to the predicted required time for charging (that is, the required time), the parking lot management device 400 may acquire the predicted required time therefor from a predetermined time, such as 5 hours when the battery capacity is “large” and 3 hours when the battery capacity is “medium”.

Next, the parking lot management device 400 determines whether or not the predicted required time is shorter than the scheduled stay time based upon the internal state information included in the vehicle information acquired in step S12, the information on the predicted stay time acquired in step S13, and the information on the predicted required time acquired in step S15 (step S16). When it is determined that the predicted required time is shorter than the scheduled stay time (YES in step S16), the user is asked whether to execute the reserved task for confirmation (step S17).

For example, if the vehicle M is a vehicle specified by the vehicle ID “KH001” recorded in the reservation information table 442 in FIG. 4, the reserved task is “charge 100%”, and thus, the parking lot management device 400 refers to the remaining battery level (the internal state information) of the vehicle M. Next, for example, if the remaining battery level of the vehicle M is 50%, the predicted required time for executing the reserved task “charge 100%” corresponds to the predicted required time of the task “charge 50%”, and thus, the parking lot management device 400 acquires information “4H” indicating the predicted required time of the task “charge 50%” by referring to the predicted required time information table 445. In this case, since the predicted required time (4 hours) is shorter than the scheduled stay time (7 hours), that is, it is determined that the reserved task can be executed, the parking lot management device 400 asks the user whether to execute the reserved task for confirmation.

Next, the parking lot management device 400 determines whether or not an instruction that the reserved task is to be executed is received (step S18). When it is determined that the instruction that the reserved task is to be executed is received (YES in step S18), the parking lot management device 400 generates a parking plan including the execution of the reserved task (step S19) and terminates the parking plan generation processing.

When it is not determined that the predicted required time is shorter than the scheduled stay time (NO in step S16), the parking lot management device 400 notifies the user of the vehicle M that the reserved task cannot be executed (step S20).

For example, if the vehicle M is a vehicle specified by the vehicle ID “KH001” recorded in the reservation information table 442 in FIG. 4 and the remaining battery level of the vehicle M is low, the parking lot management device 400 acquires information “8H” indicating the predicted required time of the reserved task “charge 100%” with reference to the predicted required time information table 445. In this case, since it is not determined that the predicted required time (8 hours) is shorter than the scheduled stay time (7 hours), the parking lot management device 400 notifies the user of the vehicle M that the reserved task “100% charge” cannot be executed.

Next, the parking lot management device 400 determines whether or not an instruction that another task, that is, a task other than the reserved task is desired to be executed is received from the user of the vehicle M (step S21). Further, even when it is not determined that the instruction that the reserved task is to be executed is received (NO in step S18), the parking lot management device 400 determines whether or not an instruction that another task is desired to be executed is received (step S21).

When it is determined that the instruction that another task is desired to be executed is received (YES in step S21), the parking lot management device 400 proceeds to the processing of step S31 in FIG. 8. On the other hand, when it is determined that the instruction that another task is desired to be executed is not received (NO in step S21), the parking lot management device 400 generates a parking plan that does not include any of the tasks (step S22). Next, the parking lot management device 400 notifies a user of another vehicle parked in the parking lot PA or approaching the parking lot PA that the task reserved by the user of the vehicle M can be executed (step S23) and terminates the parking plan generation processing.

Next, the processing illustrated in FIG. 9 will be described. The processing illustrated in FIG. 9 is processing performed when it is determined that there is no reserved task in the processing of step S14 illustrated in FIG. 8 (NO in step S14), and when it is determined that an instruction that another task is desired to be executed is received in the processing of step S21 (YES in step S21).

The parking lot management device 400 specifies the task that can be executed for the vehicle M based upon the scheduled stay time (step S31). More specifically, the parking lot management device 400 specifies the task whose predicted required time is shorter than the scheduled stay time based upon the internal state information included in the vehicle information acquired in step S12, the information on the predicted stay time acquired in step S13, and the information on the predicted required time acquired in step S15.

For example, if the vehicle M is a vehicle specified by the vehicle ID “KH001” illustrated in FIG. 4, the scheduled stay time is “7 hours”, and thus, a task whose predicted required time is shorter than “7 hours” in consideration of the internal state information of the vehicle M is specified with reference to the predicted required time information table 445. In this example, “car wash” (the predicted required time is “1 hour”), “charge (50%)” (the predicted required time is “4 hours”), or the like is specified.

Next, the parking lot management device 400 determines whether or not there is an executable task for the vehicle M, that is, whether or not an executable task has been specified by the processing of step S31 (step S32). When it is determined that there is no executable task for the vehicle M (NO in step S32), the parking lot management device 400 generates a parking plan that does not include any tasks (step S36) and terminates the parking plan generation processing.

On the other hand, when it is determined that there is an executable task for the vehicle M (YES in step S32), the parking lot management device 400 notifies the user of the vehicle M of the executable task (step S33).

Next, the parking lot management device 400 determines whether or not an instruction that the task notified by the processing of step S33 is to be executed is received from the user of the vehicle M (step S34). When it is determined that the instruction that the notified task is to be executed is not received (NO in step S34), the parking lot management device 400 generates a parking plan that does not include any tasks (step S36) and terminates the parking plan generation processing.

On the other hand, when it is determined that the instruction that the notified task is to be executed is received (YES in step S34), the parking lot management device 400 generates a parking plan including the execution of the notified task (step S35) and terminates the parking plan generation processing.

The present invention is not limited to the above-described embodiment and can be appropriately modified, improved, or the like. For example, in the above-described embodiment, an example in which the moving body is defined as the vehicle is described, but the present invention is not limited thereto. The idea of the present invention can be applied not only to the vehicle but also to a robot, a ship, an aircraft, or the like which is provided with a drive source and can be moved by the power of the drive source. Further, in the same manner, the accommodation area may be a hangar, a berth, a parking apron (an apron), or the like. Further, automatic driving is a concept that includes autonomous movement.

Further, in the above-described embodiment, an example in which various services such as car wash, charging, or the like provided to the vehicle in the parking lot PA are defined as tasks is described but the present invention is not limited thereto. For example, the task may include a reservation for the vehicle M to exit from the parking lot PA. That is, for example, before the vehicle M approaches the parking lot PA (for example, at the time of making a reservation for using the parking lot PA), the scheduled exit date and time are inputted, and when the vehicle M approaches the parking lot PA (for example, the vehicle M arrives before the entrance gate EN), the scheduled exit date and time is inputted again and the vehicle M may exit from the parking lot PA when the scheduled exit date and time are reached.

Further, at least the following items are described in this specification. The components or the like corresponding to the above-described embodiments are shown in parentheses, and the present invention is not limited thereto.

(1) An accommodation area management device (parking lot management device 400) configured to manage an accommodation area (parking lot PA) capable of accommodating a moving body (vehicle M), the accommodation area being an area capable of executing a predetermined task for the accommodated moving body, the accommodation area management device including:

a reception unit (reception unit 421) configured to receive, from a user of the moving body, an instruction that the task is to be executed for the moving body; and

a processing unit (processing unit 422) configured to perform processing of generating an accommodation plan for the moving body when the moving body is accommodated in the accommodation area, where

before the moving body approaches the accommodation area and when the moving body approaches the accommodation area, the reception unit can receive from the user the instruction that the task is to be executed for the moving body, and

the processing unit generates the accommodation plan including the execution of the task if the instruction that the task is to be executed for the moving body is received before the moving body approaches the accommodation area and the instruction that the task is to be executed for the moving body is received again when the moving body approaches the accommodation area.

According to (1), when the user of the moving body is willing to execute the task when the moving body approaches the accommodation area, an accommodation plan including the execution of the task for the moving body can be generated, thereby making it possible to efficiently perform the task and to effectively utilize the accommodation area.

(2) The accommodation area management device according to (1), where

the processing unit generates the accommodation plan that does not include the execution of the task for the moving body if the instruction that the task is to be executed for the moving body is received before the moving body approaches the accommodation area, but the instruction that the task is to be executed for the moving body is not received when the moving body approaches the accommodation area.

According to (2), when the user of the moving body is not willing to execute the task when the moving body approaches the accommodation area, an accommodation plan that does not include the execution of the task for the moving body can be generated, thereby making it possible to efficiently perform the task and to effectively utilize the accommodation area.

(3) The accommodation area management device according to (1) or (2), further including:

a required time acquisition unit configured to acquire required time when the task is executed for the moving body; and

a stay time acquisition unit configured to acquire scheduled stay time for the moving body to stay in the accommodation area, where

the processing unit generates the accommodation plan including the execution of the task for the moving body when the required time is shorter than the scheduled stay time.

According to (3), since an accommodation plan including the execution of the task for the moving body is generated on the condition that the predicted required time of the task is shorter than the scheduled stay time of the moving body in the accommodation area, it is possible to prevent an accommodation plan that cannot be executed from being generated and to improve the convenience of the user of the moving body.

(4) The accommodation area management device according to any one of (1) to (3), further including:

a required time acquisition unit (required time acquisition unit 423) configured to acquire required time when the task is executed for the moving body; and

a stay time acquisition unit (stay time acquisition unit 424) configured to acquire scheduled stay time for the moving body to stay in the accommodation area, where

the processing unit further performs processing of notifying the user of other tasks that can be executed within the scheduled stay time, when the required time is longer than the scheduled stay time.

According to (4), when the required time for the task is longer than the scheduled stay time of the moving body in the accommodation area, the user of the moving body is notified of other tasks that can be executed within the scheduled stay time, thereby making it possible to increase the opportunity of executing other tasks and to effectively utilize the accommodation area.

(5) The accommodation area management device according to any one of (1) to (4), where

the processing unit further performs processing of notifying a user of another moving body accommodated in the accommodation area or approaching the accommodation area that a reserved task can be executed if the instruction that the reserved task is to be executed is not received from the user when the moving body approaches the accommodation area.

According to (5), when the execution of the task reserved by the user of the moving body is canceled, the user of another moving body accommodated in the accommodation area or approaching the accommodation area is notified that the reserved task can be executed, thereby making it possible to increase the opportunity of executing the task and to effectively utilize the accommodation area.

(6) The accommodation area management device according to any one of (1) to (5), where

the processing unit further performs processing of notifying the user of a task that can be executed in the accommodation area when the moving body approaches the accommodation area if the instruction that any task is to be executed is not received from the user before the moving body approaches the accommodation area.

According to (6), if the instruction that any task is to be executed is not received from the user of the moving body before the moving body approaches the accommodation area, the user is notified of the tasks that can be executed in the accommodation when the moving body approaches the accommodation area, thereby making it possible to increase the opportunity of executing the task and to effectively utilize the accommodation area.

(7) The accommodation area management device according to any one of (1) to (6), where

the processing unit further performs processing of temporarily stopping the moving body at a predetermined position.

According to (7), it is possible to increase the opportunity of executing the task and to effectively utilize the accommodation area.

1. An accommodation area management device configured to manage an accommodation area capable of accommodating a moving body, the accommodation area being an area capable of executing a predetermined task for the accommodated moving body, the accommodation area management device comprising:
a reception unit configured to receive from a user of the moving body an instruction that the task is to be executed for the moving body; and
a processing unit configured to perform processing of generating an accommodation plan for the moving body when the moving body is accommodated in the accommodation area, wherein:
before the moving body approaches the accommodation area and when the moving body approaches the accommodation area, the reception unit can receive from the user the instruction that the task is to be executed for the moving body; and
the processing unit generates the accommodation plan including the execution of the task if the instruction that the task is to be executed for the moving body is received before the moving body approaches the accommodation area and the instruction that the task is to be executed for the moving body is received again when the moving body approaches the accommodation area.

2. The accommodation area management device according to claim 1, wherein
the processing unit generates the accommodation plan that does not include the execution of the task for the moving body if the instruction that the task is to be executed for the moving body is received before the moving body approaches the accommodation area, but the instruction that the task is to be executed for the moving body is not received when the moving body approaches the accommodation area.

3. The accommodation area management device according to claim 1, further comprising:
a required time acquisition unit configured to acquire required time when the task is executed for the moving body; and
a stay time acquisition unit configured to acquire scheduled stay time for the moving body to stay in the accommodation area, wherein
the processing unit generates the accommodation plan including the execution of the task for the moving body when the required time is shorter than the scheduled stay time.

4. The accommodation area management device according to claim 1, further comprising:
a required time acquisition unit configured to acquire required time when the task is executed for the moving body; and
a stay time acquisition unit configured to acquire scheduled stay time for the moving body to stay in the accommodation area, wherein
the processing unit further performs processing of notifying the user of other tasks that can be executed within the scheduled stay time when the required time is longer than the scheduled stay time.

5. The accommodation area management device according to claim 1, wherein
the processing unit further performs processing of notifying a user of another moving body accommodated in the accommodation area or approaching the accommodation area that a reserved task can be executed if the instruction that the reserved task is to be executed is not received from the user when the moving body approaches the accommodation area.

6. The accommodation area management device according to claim 1, wherein
the processing unit further performs processing of notifying the user of a task that can be executed in the accommodation area when the moving body approaches the accommodation area if the instruction that any task is to be executed is not received from the user before the moving body approaches the accommodation area.

7. The accommodation area management device according to claim 1, wherein
the processing unit further performs processing of temporarily stopping the moving body at a predetermined position.
